(19) United States
(12) Patent Application Publication
(10) Pub. No.: US 2013/0184502 A1
(43) Pub. Date: Jul. 18, 2013

(54) REDUCED WATER CONTENT PREPARATION PROCESS FOR HYDROGENATION CATALYSTS

(71) Applicant: Celanese International Corporation, Irving, TX (US)

(72) Inventors: Zhenhua Zhou, Houston, TX (US); Heiko Weiner, Pasadena, TX (US)

(73) Assignee: Celanese International Corporation, Irving, TX (US)

(21) Appl. No.: 13/734,574

(22) Filed: Jan. 4, 2013

Related U.S. Application Data
(63) Continuation-in-part of application No. 13/595,365, filed on Aug. 27, 2012.
(60) Provisional application No. 61/583,874, filed on Jan. 6, 2012.

(51) Int. Cl. B01J 23/89

(52) U.S. Cl. CPC B01J 23/8993
USPC 568/885; 502/339

(57) ABSTRACT

The present invention relates to processes for making catalysts, to catalyst prepared by a specific process, and to chemical processes employing such catalysts. The catalysts are preferably used for converting acetic acid to ethanol. The catalyst comprises less than 20% solvent prior to calcining.

### CROSS REFERENCE TO RELATED APPLICATION

This application is a continuation-in-part of U.S. application Ser. No. 13/595,365, filed Aug. 27, 2012, which claims priority to U.S. Provisional App. No. 61/583,874, filed on Jan. 6, 2012, the entirety of which is incorporated herein by reference.

### FIELD OF THE INVENTION

The present invention relates to processes for producing ethanol in the presence of catalysts comprising one or more active metals, wherein the catalyst is made by impregnating the catalyst with a precursor solution comprising a solvent and a precursor to the one or more active metals on a support material in an aqueous medium, drying the catalyst to less than 20 wt. % water and calcining the catalyst. The present invention also relates to catalysts made by the inventive process. When catalysts made by this process are used in the hydrogenation of acetic acid and/or esters thereof to ethanol, acetic acid and/or esters thereof conversion and selectivity of acetic acid and/or esters thereof to ethanol are high.

### BACKGROUND OF THE INVENTION

Ethanol for industrial use is conventionally produced from petrochemical feed stocks, such as oil, natural gas, or coal, from feed stock intermediates, such as syngas, or from starchy materials or cellulosic materials, such as corn or sugar cane. Conventional methods for producing ethanol from petrochemical feed stocks, as well as from cellulosic materials, include the acid-catalyzed hydration of ethylene, methanol homologation, direct alcohol synthesis, and Fischer-Tropsch synthesis. Instability in petrochemical feed stock prices contributes to fluctuations in the cost of conventionally produced ethanol, making the need for alternative sources of ethanol production all the greater when feed stock prices rise. Starchy materials, as well as cellulosic material, are converted to ethanol by fermentation. However, fermentation is typically used for consumer production of ethanol, which is suitable for fuels or human consumption. In addition, fermentation of starchy or cellulosic materials competes with food sources and places restraints on the amount of ethanol that can be produced for industrial use.

Ethanol production via the reduction of alkanoic acids and/or other carbonyl group-containing compounds has been widely studied, and a variety of combinations of catalysts, supports, and operating conditions have been mentioned in the literature. The reduction of various carboxylic acids over metal oxides has been proposed by EP0175558 and U.S. Pat. No. 4,398,039. A summary some of the developmental efforts for hydrogenation catalysts for conversion of various carboxylic acids is provided in Yokoyama, et al., “Carboxylic acids and derivatives” in: Fine Chemicals Through Heterogeneous Catalysis, 2001, 370-379.

U.S. Pat. No. 6,495,730 describes a process for hydrogenating carboxylic acid using a catalyst prepared by impregnating an activated carbon with a concentrated aqueous zinc chloride solution, followed by calcinations. U.S. Pat. No. 6,204,417 describes another process for preparing aliphatic alcohols by hydrogenating aliphatic carboxylic acids or anhydrides or esters thereof or lactones in the presence of a catalyst comprising Pt, Re, and at least one further element from groups 5 to 12 and 14 the lanthanides of the Periodic Table of the Elements. The catalyst is obtainable by reducing an aqueous suspension and/or solution of a metal precursor that may be oxides, oxide hydrates, carbonates, nitrates, carboxylates, chelates, sulfates, phosphates and/or halides. The catalyst may be supported or unsupported. U.S. Pat. No. 5,149,680 describes a process for the catalytic hydrogenation of carboxylic acids and their anhydrides to alcohols and/or esters in the presence of a catalyst containing a Group VIII metal, such as palladium, a metal capable of alloying with the Group VIII metal, and at least one of the metals rhenium, tungsten or molybdenum. The catalyst may be produced by I) impregnating a support with a solution or solutions of (i) at least one soluble Group VIII noble metal compound thermally decomposable/reducible to the noble metal and (ii) a soluble compound thermally decomposable/reducible to the metal of at least one metal capable of alloying with the Group VIII noble metal and removing t solvent therefrom; II) heating the composition obtain in step I) under conditions and at a temperature such that the compounds are thermally decomposed/reduced to the metals and form an alloy thereof, and III) impregnating the composition obtained in step II) with a compound of at least one of the metals rhenium, tungsten or molybdenum and removing the solvent therefrom. U.S. Pat. No. 4,777,303 describes a process for the productions of alcohols by the hydrogenation of carboxylic acids in the presence of a catalyst that comprises a first component which is either molybdenum or tungsten and a second component which is a noble metal of Group VIII on a high surface area graphitized carbon. The catalysts may be prepared by heat treating high surface area graphitized carbon and grinding it to 16-30 mesh BSS. An aqueous solution of the first component and/or the second components are added to the carbon. The solvent is removed in a rotary evaporator and the catalyst is dried overnight in a vacuum oven. U.S. Pat. No. 4,804,791 describes another process for the production of alcohols by the hydrogenation of carboxylic acids in the presence of a catalyst prepared by heat treating a carbon support material. A noble metal and rhenium may then be co-impregnated or sequentially impregnated. U.S. Pat. No. 4,517,391 describes preparing ethanol by hydrogenating acetic acid under superatmospheric pressure and at elevated temperatures in the presence of a cobalt-containing catalyst. The catalyst is prepared in a convention manner from an appropriate mixture of metal oxides, with or without further components, e.g., phosphoric acid, and by heating this mixture for a few hours in a stream of hydrogen. During this procedure, the major part of each of the oxides is reduced to the metal.

Existing processes suffer from a variety of issues impeding commercial viability including: (i) catalysts without requisite conversion of acetic acid and/or an ester thereof; (ii) catalysts without requisite selectivity to ethanol; (iii) catalysts which are nonselective for the formation of ethanol and that produce undesirable by-products; and (iv) insufficient catalyst life.

### SUMMARY OF THE INVENTION

In a first embodiment, the invention is directed to a process for producing ethanol, comprising contacting a feedstock comprising acetic acid, ethyl acetate and mixtures thereof with hydrogen in a reactor at an elevated temperature in the presence of a catalyst comprising one or more active metals, under conditions effective to form ethanol; wherein the catalyst is prepared by impregnating a support with at least one precursor solution comprising a solvent and at least one precursor to the one or more active metals; drying the impregnated support to a water content of less than 20 wt. %; and calcining the dried catalyst to form the catalyst.

In a second embodiment, the present invention is directed to a hydrogenation catalyst comprising one or more active metals selected from the group consisting of rhodium, rhenium, ruthenium, platinum, palladium, osmium, iridium, gold copper, iron, vanadium, tin, cobalt, nickel, titanium, zinc, chromium, molybdenum, tungsten, lanthanum, cerium, and manganese; wherein the catalyst is prepared by impregnating a support with at least one precursor solution comprising a solvent and at least one precursor to the one or more active metals; drying the impregnated support to a water content of less than 20 wt. %; and calcining the dried catalyst to form the catalyst.

### BRIEF DESCRIPTION OF THE DRAWINGS

The present invention will be better understood in view of the appended non-limiting figures, in which:

FIG. 1 shows a graph of acetic acid conversion over time on stream in accordance with one embodiment of the invention.

### DETAILED DESCRIPTION OF THE INVENTION

### Processes for Making the Catalyst

The present invention is directed to catalysts made under specific process conditions and to processes of using the inventive catalysts for converting acetic acid and/or an ester thereof to ethanol. The catalysts comprise one or more active metals on a support. The active metals include copper, iron, cobalt, vanadium, nickel, titanium, zinc, chromium, molybdenum, tungsten, tin, lanthanum, cerium, manganese, rhodium, rhenium, ruthenium, platinum, palladium, osmium, iridium or gold. In one embodiment, the active metals include copper, iron, cobalt, zinc, chromium, molybdenum, tungsten, tin, platinum, or palladium. The support may be an inorganic oxide, such as, but not limited to, silica, alumina, titania, silica/alumina, or zirconia. As described herein the support may be modified with support modifier.

The catalysts are prepared by impregnating a support with a precursor solution comprising at least one precursor to the one or more active metals. The precursor solution comprises a solvent, such as water, glacial acetic acid, nitric acid or an organic solvent. The precursors may include metal halides, hydroxides, nitrates, or oxalates. To deposit the active metals on the support, the present invention uses an incipient wetness method in which the volume of the precursor solution may be from 90 to 100% of the absorptive capacity of the support, and more preferably from 95 to 98%. Impregnation occurs by adding, optionally dropwise, the precursor solution to the support. There may be multiple precursor solutions that are impregnated with a support. Capillary action draws the active metal into the pores of the support. The catalyst solution, i.e. impregnated catalyst, is dried, optionally under vacuum, to drive off solvents and any volatile components and thereby depositing the active metal on the support material to form the impregnated catalyst. Prior to drying, the catalyst solution comprises at least 20 wt. % water, e.g., at least 25 wt. % or at least 30 wt. %. The drying should be sufficient to reduce the water content of the impregnated catalyst to less than 20 wt. %. Surprisingly and unexpectedly the inventors have found that when calcining an impregnated catalyst with a water content of less than 20 wt. % produces a catalyst with increased catalytic performance. In particular the catalysts of the present invention may achieve stable productivity rates at high conversion and/or selectivity. It is understood that when the solvent is glacial acetic acid, nitric acid or an organic solvent, the catalyst is dried to a respective content of less than 20 wt. % glacial acetic acid, nitric acid or organic solvent prior to calcining.

Without being bound by theory, it is believed that by reducing the water content to less than 20 wt. % prior to calcination prevents adverse changes to the surface of the catalyst, such as cracking. Reducing or avoiding these changes may improve the dispersion of the active metal on the catalyst. A dispersed active metal may be desired at lower loadings of less than 3 wt. %. Increasing dispersion on the catalyst is believed to improve catalytic performance. In addition, reducing or avoiding these changes may beneficial affect the amount and placement of acidic sites on the catalyst.

Depending on the metal precursors employed, the use of a solvent, such as water, glacial acetic acid, nitric acid, an organic solvent or mixtures thereof, may help solubilize one or more of the active metal precursors. In particular a solvent comprising water is described herein. When the solvent does not contain water, it is understood that the drying step reduces the solvent concentration of less than 20 wt. %. The precursor solution may be prepared so that the soluble portion is appropriate for the support. Usually, the precursor solution is prepared with an excess amount of water. To impregnate the support with the desired amount of active metals, a large amount of water also is present with the support. Each support can absorb different quantities of water, which may be determined empirically and adjusted accordingly. The water may be trapped within the catalyst when depositing the active metals. In one embodiment, due to the solubility limits of the precursors to the one or more active metals, there may be multiple impregnations with intermediate drying. The multiple impregnations may be of the same precursor solution, i.e. same active metal in each solution, or of different precursor solutions. The impregnation may be sequential or co-impregnation of the at least one active metal. Sequential impregnation refers to two precursor solutions that are impregnated. Co-impregnation refers to a precursor solution that comprises two or more active metal precursors. In some embodiments, the same active metal(s) may be sequentially impregnated, such as in a sequential co-impregnation.

The impregnated catalyst is then dried in air or oxygen to a water content of less than 20 wt. %. The drying process for the catalyst after impregnation may include vacuum drying, oven drying, or other drying processes known in the art. The catalyst is dried under conditions effective to provide a catalyst, prior to calcining, with a water content of less than 20 wt. %, e.g., less than 18 wt. %, less than 15 wt. %, less than 10 wt. %, or less than 8 wt. %. In terms of ranges, the water content, prior to calcining, may range from 0.1 to 18 wt. %, e.g., from 1 to 17 wt. %, from 5 to 18 wt. %, or from 5 to 15 wt. %. The catalyst's water content may be measured periodically during the drying process.

As described above, any or combinations of numerous drying methods may be used. In one embodiment, the catalyst solution is dried at a temperature from 100° C. to 140° C., from 110° C. to 130° C., from 1 to 12 hours, e.g., from 2 to 10 hours, from 4 to 8 hours or about 6 hours. The drying time may be adjusted as need to achieve the desired water concentration of less than 20 wt. %. In some embodiments, using a combination of vacuum and oven drying, the catalyst solution may be dried for at least 10 hours prior to calcining, e.g., at least 12 hours or at least 15 hours. The catalyst solution may be dried for 1 hour in an oven, followed by at least 9 hours in a vacuum, e.g., 11 hours or 14 hours in a vacuum.

Once the water content is less than 20 wt. %, the catalyst is thermally treated in the presence of air or oxygen. Generally, calcination is conducted immediately after drying to avoid the catalyst solution from picking up any water. Calcination may vary depending on the desired metal for the catalyst. The calcination temperature may start at a temperature at is from 100° C. to 160° C. and is steadily ramped to a higher temperature to complete the calcination. Initially, the calcination temperature may be held for 0.2 to 3 hours at a temperature from 100° C. to 160° C. and further drying of the catalyst solution may occur. In general, calcination may be conducted at a temperature from 200° C. to 500° C., from 300° C. to 400° C., or about 350° C., for a period from 1 to 12 hours, e.g., from 2 to 10 hours, from 4 to 8 hours or about 6 hours.

The activating step, or reducing step, may be carried out immediately after drying/calcining or delayed until the activated catalyst is needed. Reduction is carried out in the presence of a reducing gas, preferably hydrogen. The reducing gas is optionally continuously passed over the catalyst at an initial ambient temperature that is increased up to 400° C. In one embodiment, the reduction is carried out after the catalyst has been loaded into the reaction vessel where the hydrogenation will be carried out.

Once formed, the modified supports may be shaped into particles having the desired size distribution, e.g., to form particles having an average particle size in the range from 0.2 to 0.4 cm. The supports may be extruded, pelletized, tabletized, pressed, crushed or sieved to the desired size distribution. Any of the known methods to shape the support materials into desired size distribution can be employed. Alternatively, support pellets may be used as the starting material used to make the modified support and, ultimately, the final catalyst.

The inventive process for making the catalyst improves the conversion of acetic acid and/or an ester thereof. The process also improves the lifetime of the catalyst. Without being bound by theory, it is believed that by reducing the water content to less than 20 wt. % prior to calcining, adverse changes to the surface of the catalyst, such as cracking, during calcining are reduced and may be avoided. Reducing or avoiding these changes may improve the dispersion of the at least one active metal. Increasing dispersion on the catalyst is believed to improve catalytic performance. In addition, reducing or avoiding these changes may beneficially affect the amount and placement of acidic sites on the catalyst.

In one embodiment, separate precursor solutions of the metal precursors are formed, which are subsequently blended prior to being impregnated with the support. For example, a first solution may be formed comprising a first metal precursor, and a second solution may be formed comprising the second metal precursor and optionally the third metal precursor, that are different the first metal precursor. At least one of the metal precursors preferably is tin, cobalt, or platinum. Either or both solutions preferably comprise a solvent, such as water, glacial acetic acid, hydrochloric acid, nitric acid or an organic solvent. The first solution may be impregnated, and dried. If dried to a water concentration of less than 20 wt. %, then the dried catalyst may be calcined. After the initial drying, and calcination if any, the second solution may be added. Prior to calcinations, the catalyst is dried to less than 20 wt. % water. Additional precursor solutions may be added as needed to the support, provided that prior to any calcination the catalyst is dried to 20 wt. %.

In one exemplary embodiment, a first solution comprising a first metal precursor and a second metal precursor is prepared. The solvent for the first solution comprises water. The first metal precursor may be a metal halide and may comprise a tin halide, e.g., a tin chloride such as tin (II) chloride and/or tin (IV) chloride. The second metal precursor preferably comprises a second metal oxalate, acetate, halide or nitrate, e.g., cobalt nitrate. A second solution, using water as a solvent, is also prepared comprising a metal halide, such as a halide of rhodium, rhenium, ruthenium, platinum or palladium. The second solution is combined with the first solution to form a mixed metal precursor solution. The resulting mixed metal precursor solution may then be added to the support followed by drying and calcining to form the final catalyst composition as described above.

In another embodiment, a precursor solution comprising a first metal precursor and a second metal precursor is prepared. The first and second metal precursors may comprise tin and platinum. The precursor solution may be divided into portions. A first portion, preferably from 30 to 80%, is impregnated onto the support and dried as needed. The support may then be dried, e.g., for at least 5 hours, at least 10 hours, or at least 15 hours. Because calcination occurs after the second portion is impregnated then water concentration for the intermediate drying may vary. The remaining portion of the precursor solution is then impregnated onto the support and dried to a water concentration of less than 20 wt. %. Once sufficiently dried the catalyst may be calcined. This method of impregnating the mixed metal solution twice may be particularly advantageous when the solubility limits are reached for the support. Thus, by impregnating the support twice and drying in between impregnations, the desired amount of precursor is loaded onto the support while water content is controlled.

The specific precursors used in the various embodiments of the invention may vary widely. Suitable metal precursors may include, for example, metal halides, amine solubilized metal hydroxides, metal nitrates or metal oxalates. For example, suitable compounds for platinum precursors and palladium precursors include chloroplatinic acid, ammonium chloroplatinate, amine solubilized platinum hydroxide, platinum nitrate, platinum tetra ammonium nitrate, platinum chloride, platinum oxalate, palladium nitrate, palladium tetra ammonium nitrate, palladium chloride, palladium oxalate, sodium palladium chloride, sodium platinum chloride, and platinum ammonium nitrate, Pt(NH₃)₄(NO₄)₂. Generally, both from the point of view of economics and environmental aspects, aqueous solutions of soluble compounds of platinum and palladium are preferred. In one embodiment, the precious metal precursor is not a metal halide and is substantially free of metal halides, while in other embodiments, as described above, the precious metal precursor is a halide.

In one embodiment, ammonium oxalate is used to facilitate solubilizing of at least one of the metal precursors, e.g., a tin precursor, as described in U.S. Pat. No. 8,211,821, the entirety of which is incorporated herein by reference. In this aspect, the first metal precursor comprises an oxalate of a precious metal, e.g., rhodium, palladium, or platinum, and a second metal precursor comprises an oxalate tin. Another active metal precursor, if desired, comprises a nitrate, halide, acetate or oxalate of chromium, copper, or cobalt. In this aspect, a solution of the second metal precursor may be made in the presence of ammonium oxalate as solubilizing agent, and the first metal precursor may be added thereto, as a solid or a separate solution. A third metal precursor may be combined with the solution comprising the first precursor and tin oxalate precursor, or may be combined with the second metal precursor, optionally as a solid or a separate solution, prior to addition of the first metal precursor. In other embodiments, an acid such as acetic acid, hydrochloric acid or nitric acid may be substituted for the ammonium oxalate to facilitate solubilizing of the tin oxalate. The resulting mixed metal precursor solution may then be added to the support, optionally a modified support, followed by drying and calcining to form the final catalyst composition as described above.

Generally, the loadings of the active metals may be from 0.1 to 25 wt. % , e.g., from 0.5 to 15 wt. %, or from 1.0 to 10 wt. %. The one or more active metals may be selected from the group consisting of rhodium, rhenium, ruthenium, platinum, palladium, osmium, iridium, gold copper, iron, vanadium, tin, cobalt, nickel, titanium, zinc, chromium, molybdenum, tungsten, lanthanum, cerium, and manganese. Preferably, the one or more active metals are selected from the group consisting of platinum, palladium, tin, cobalt, and nickel. In one embodiment, the active metals may include at least one precious metal, such as rhodium, rhenium, ruthenium, platinum, palladium, osmium, iridium and gold. The precious metal may be in elemental form or in molecular form, e.g., an oxide of the precious metal. The catalyst may comprise the precious metal in an amount from 0.05 to 10 wt. %, e.g. from 0.1 to 5 wt. %, or from 0.1 to 3 wt. %, based on the total weight of the catalyst. In some embodiments, the metal loading of the precious metal may be less than the metal loadings of the one or more active metals.

In one embodiment, the catalyst may comprise from cobalt in an amount from 0.5 to 20 wt. %, e.g., preferably from 4.1 to 20 wt. %, and tin in an amount from 0.5 to 20 wt. %, e.g., preferably from 0.5 to 3.5 wt. %.

Preferred bimetallic combinations for some exemplary catalyst compositions include platinum/tin, platinum/ruthenium, platinum/rhenium, platinum/cobalt, platinum/nickel, palladium/ruthenium, palladium/rhenium, palladium/cobalt, palladium/copper, palladium/nickel, ruthenium/cobalt, gold/palladium, ruthenium/rhenium, ruthenium/iron, rhodium/iron, rhodium/cobalt, rhodium/nickel and rhodium/tin. In some embodiments, the catalyst comprises three metals on a support, e.g., one precious metal and two active metals. Exemplary tertiary combinations may include palladium/rhenium/tin, palladium/rhenium/cobalt, palladium/rhenium/nickel, palladium/cobalt/tin, platinum/tin/palladium, platinum/tin/rhodium, platinum/tin/gold, platinum/tin/iridium, platinum/cobalt/tin, platinum/tin/copper, platinum/tin/chromium, platinum/tin/zinc, platinum/tin/nickel, rhodium/nickel/tin, rhodium/cobalt/tin and rhodium/iron/tin.

The catalysts of the present invention comprise a suitable support. In one embodiment, the support material may be selected from the group consisting of silica, alumina, titania, silica/alumina, pyrogenic silica, high purity silica, zirconia, carbon (e.g., carbon black or activated carbon), zeolites and mixtures thereof. Preferably, the support material comprises a silicaceous support material such as silica, pyrogenic silica, or high purity silica. In one embodiment the silicaceous support material is substantially free of alkaline earth metals, such as magnesium and calcium. In preferred embodiments, the support material is present in an amount from 25 wt. % to 99 wt. %, e.g., from 30 wt. % to 98 wt. % or from 35 wt. % to 95 wt. %, based on the total weight of the catalyst.

In one embodiment, the support may be a modified support that comprises a support modifier. A support modifier may adjust the acidity of the support material. In one embodiment, a support modifier comprises a metal selected from the group consisting of tungsten, molybdenum, vanadium, niobium, and tantalum. The metal for the support modifier may be an oxide thereof. In one embodiment, the support modifiers are present in an amount from 0.1 wt. % to 50 wt. %, e.g., from 0.2 wt. % to 25 wt. %, from 0.5 wt. % to 20 wt. %, or from 1 wt. % to 15 wt. %, based on the total weight of the catalyst. When the support modifier comprises tungsten, molybdenum, and vanadium, the support modifier may be present in an amount from 0.1 to 40 wt. %, e.g., from 0.1 to 30 wt. % or from 0.1 to 20 wt. %, based on the total weight of the catalyst.

As indicated, the support modifiers may adjust the acidity of the support. For example, the acid sites, e.g., Brønsted acid sites or Lewis acid sites, on the support material may be adjusted by the support modifier to favor selectivity to ethanol during the hydrogenation of acetic acid and/or esters thereof. The acidity of the support material may be adjusted by optimizing surface acidity of the support material. The support material may also be adjusted by having the support modifier change the pKa of the support material. Unless the context indicates otherwise, the acidity of a surface or the number of acid sites thereupon may be determined by the technique described in F. Delannay, Ed., “Characterization of Heterogeneous Catalysts”; Chapter III: Measurement of Acidity of Surfaces, p. 370-404; Marcel Dekker, Inc., N.Y. 1984, the entirety of which is incorporated herein by reference. In general, the surface acidity of the support may be adjusted based on the composition of the feed stream being sent to the hydrogenation process in order to maximize alcohol production, e.g., ethanol production.

In some embodiments, the support modifier may be an acidic modifier that increases the acidity of the catalyst. Suitable acidic support modifiers may be selected from the group consisting of: oxides of Group IVB metals, oxides of Group VB metals, oxides of Group VIB metals, oxides of Group VIIB metals, oxides of Group VIII metals, aluminum oxides, and mixtures thereof. In one embodiment, the support modifier comprises metal selected from the group consisting of tungsten, molybdenum, vanadium, niobium, and tantalum.

In one embodiment, the acidic modifier may also include those selected from the group consisting of WO₃, MoO₃, V₂O₅, VO₂, V₂O₃, Nb₂O₅, Ta₂O₅, FeO, Fe₃O₄, Fe₂O₃, Cr₂O₃, MnO₂, CoO, Co₂O₃, and Bi₂O₃. Reduced tungsten oxides or molybdenum oxides may also be employed, such as, for example, one or more of W₂₀O₅₈, WO₂, W₄₉O₁₁₉, W₅₀O₁₄₈, W₁₈O₄₉, Mo₉O₂₆, Mo₈O₂₃, Mo₅O₁₄, Mo₁₇O₄₇, Mo₄O₁₁, or MoO₂. In one embodiment, the tungsten oxide may be cubic tungsten oxide (H_{0.5}WO₃). It has now surprisingly and unexpectedly been discovered that the use of such metal oxide support modifiers in combination with a precious metal and one or more active metals may result in catalysts having multifunctionality, and which may be suitable for converting a carboxylic acid, such as acetic acid, as well as corresponding esters thereof, e.g., ethyl acetate, to one or more hydrogenation products, such as ethanol, under hydrogenation conditions.

In other embodiments, the acidic support modifiers include those selected from the group consisting of TiO₂, ZrO₂, Nb₂O₅, Ta₂O₅, Al₂O₃, B₂O₃, P₂O₅, and Sb₂O₃. Acidic support modifiers include those selected from the group consisting of TiO₂, ZrO₂, Nb₂O₅, Ta₂O₅, and Al₂O₃.

In some embodiments, the acidic support modifier comprises a mixed metal oxide comprising at least one of the active metals, in particular tin or cobalt, and an oxide anion of a Group IVB, VB, VIB, VIII metal, such as tungsten, molybdenum, vanadium, niobium or tantalum. The oxide anion, for example, may be in the form of a tungstate, molybdate, vanadate, or niobate. Exemplary mixed metal oxides include cobalt tungstate, copper tungstate, iron tungstate, zirconium tungstate, manganese tungstate, cobalt molybdate, copper molybdate, iron molybdate, zirconium molybdate, manganese molybdate, cobalt vanadate, copper vanadate, iron vanadate, zirconium vanadate, manganese vanadate, cobalt niobate, copper niobate, iron niobate, zirconium niobate, manganese niobate, cobalt tantalate, copper tantalate, iron tantalate, zirconium tantalate, and/or manganese tantalate. In one embodiment, the catalyst does not comprise tin tungstate and is substantially free of tin tungstate. It has now been discovered that catalysts containing such mixed metal support modifiers may provide the desired degree of multifunctionality at increased conversion, e.g., increased ester conversion, and with reduced byproduct formation, e.g., reduced diethyl ether formation.

The support modifier may be impregnated using the incipient wetness techniques described herein. A suitable precursor, including polyoxometalates (POMs) or heteropoly acids (HPAs), may be used for the support modifier. A non-limiting list of suitable POMs includes phosphotungstic acid (H—PW₁₂) (H₃PW₁₂O₄₀.nH₂O), ammonium metatungstate (AMT) ((NH₄)₆H₂W₁₂O₄₀.H₂O), ammonium heptamolybdate tetrahydrate, (AHM) ((NH₄)₆Mo₇O₂₄.4H₂O), silicotungstic acid hydrate (H—SiW₁₂) (H₄SiW₁₂O₄₀.H₂O), silicomolybdic acid (H—SiMo₁₂) (H₄SiMo₁₂O₄₀.nH₂O), and phosphomolybdic acid (H—PMo₁₂) (H₃PMo₁₂O₄₀.nH₂O). In other embodiments, the support modifier may be added as particles to the support material. For example, one or more support modifier precursors, if desired, may be added to the support material by mixing the support modifier particles with the support material, preferably in water. When mixed it is preferred for some support modifiers to use a powdered material of the support modifiers. If a powdered material is employed, the support modifier may be pelletized, crushed and sieved prior to being added to the support.

In another example, the second and third metals are co-impregnated with the precursor to WO₃ on the support, optionally forming a mixed oxide with WO₃, e.g., cobalt tungstate, followed by drying and calcination. The resulting modified support may be impregnated with one or more of the active metals, as described above, followed by a second drying and calcination step. The second drying step is important to achieve a water concentration of less than 20 wt. %. In this manner, cobalt tungstate may be formed on the modified support. Again, the temperature of the second calcining step preferably is less than the temperature of the first calcining step.

The present invention is directed to catalyst compositions that preferably are suitable as hydrogenation catalysts, to processes for forming such catalysts, and to chemical processes employing such catalysts. The catalysts preferably comprise one or more active metals on a support, preferably a modified support, and may be suitable in catalyzing the hydrogenation of a carboxylic acid, e.g., acetic acid, and/or esters thereof, e.g., ethyl acetate, to the corresponding alcohol, e.g., ethanol.

One advantage of catalysts of the present invention is the stability or activity of the catalyst for producing ethanol. Accordingly, it can be appreciated that the catalysts of the present invention are fully capable of being used in commercial scale industrial applications for hydrogenation of acetic acid, particularly in the production of ethanol. In particular, it is possible to achieve such a degree of stability such that catalyst activity will have a rate of productivity decline that is less than 6% per 100 hours of catalyst usage, e.g., less than 3% per 100 hours or less than 1% per 100 hours. Preferably, the rate of productivity decline is determined once the catalyst has achieved steady-state conditions. When the catalyst has been dried to comprise less than 20 wt. % water prior to calcining, the conversion of acetic acid is greater than 95% over a period of at least 250 hours.

The raw materials, acetic acid and hydrogen, fed to the reactor used in connection with the process of this invention may be derived from any suitable source including natural gas, petroleum, coal, biomass, and so forth. As examples, acetic acid may be produced via methanol carbonylation, acetaldehyde oxidation, ethane oxidation, oxidative fermentation, and anaerobic fermentation. Methanol carbonylation processes suitable for production of acetic acid are described in U.S. Pat. Nos. 7,208,624; 7,115,772; 7,005,541; 6,657,078; 6,627,770; 6,143,930; 5,599,976; 5,144,068; 5,026,908; 5,001,259; and 4,994,608, the entire disclosures of which are incorporated herein by reference. Optionally, the production of ethanol may be integrated with such methanol carbonylation processes.

As petroleum and natural gas prices fluctuate becoming either more or less expensive, methods for producing acetic acid and intermediates such as methanol and carbon monoxide from other carbon sources have drawn increasing interest. In particular, when petroleum is relatively expensive, it may become advantageous to produce acetic acid from synthesis gas (“syngas”) that is derived from other available carbon sources. U.S. Pat. No. 6,232,352, the entirety of which is incorporated herein by reference, for example, teaches a method of retrofitting a methanol plant for the manufacture of acetic acid. By retrofitting a methanol plant, the large capital costs associated with CO generation for a new acetic acid plant are significantly reduced or largely eliminated. All or part of the syngas is diverted from the methanol synthesis loop and supplied to a separator unit to recover CO, which is then used to produce acetic acid. In a similar manner, hydrogen for the hydrogenation step may be supplied from syngas.

In some embodiments, some or all of the raw materials for the above-described acetic acid hydrogenation process may be derived partially or entirely from syngas. For example, the acetic acid may be formed from methanol and carbon monoxide, both of which may be derived from syngas. The syngas may be formed by partial oxidation reforming or steam reforming, and the carbon monoxide may be separated from syngas. Similarly, hydrogen that is used in the step of hydrogenating the acetic acid to form the crude ethanol stream may be separated from syngas. The syngas, in turn, may be derived from variety of carbon sources. The carbon source, for example, may be selected from the group consisting of natural gas, oil, petroleum, coal, biomass, and combinations thereof. Syngas or hydrogen may also be obtained from bio-derived methane gas, such as bio-derived methane gas produced by landfills or agricultural waste.

Examples of biomass include, but are not limited to, agricultural wastes, forest products, grasses, and other cellulosic material, timber harvesting residues, softwood chips, hardwood chips, tree branches, tree stumps, leaves, bark, sawdust, off-spec paper pulp, corn, corn stover, wheat straw, rice straw, sugarcane bagasse, switchgrass, miscanthus, animal manure, municipal garbage, municipal sewage, commercial waste, grape pumice, almond shells, pecan shells, coconut shells, coffee grounds, grass pellets, hay pellets, wood pellets, cardboard, paper, plastic, and cloth. Black liquor, which is an aqueous solution of lignin residues, hemicellulose, and inorganic chemicals, may also be used as a biomass source. Biomass-derived syngas has a detectable ¹⁴C isotope content as compared to fossil fuels such as coal or natural gas.

In another embodiment, the acetic acid used in the hydrogenation step may be formed from the fermentation of biomass. Exemplary fermentation processes for forming acetic acid are disclosed in U.S. Pat. Nos. 6,509,180; 6,927,048; 7,074,603; 7,507,562; 7,351,559; 7,601,865; 7,682,812; and 7,888,082, the entireties of which are incorporated herein by reference.

The acetic acid fed to the hydrogenation reactor may also comprise acetic anhydride, acetaldehyde, ethyl acetate, propionic acid, water, and mixtures thereof.

The acetic acid may be vaporized at the reaction temperature, following which the vaporized acetic acid may be fed along with hydrogen in an undiluted state or diluted with a relatively inert carrier gas, such as nitrogen, argon, helium, carbon dioxide and the like. For reactions run in the vapor phase, the temperature should be controlled in the system such that it does not fall below the dew point of acetic acid. In one embodiment, the acetic acid may be vaporized at the boiling point of acetic acid at the particular pressure, and then the vaporized acetic acid may be further heated to the reactor inlet temperature. In another embodiment, the acetic acid is mixed with other gases before vaporizing, followed by heating the mixed vapors up to the reactor inlet temperature. Preferably, the acetic acid is transferred to the vapor state by passing hydrogen and/or recycle gas through the acetic acid at a temperature at or below 125° C., followed by heating of the combined gaseous stream to the reactor inlet temperature.

The reactor, in some embodiments, may include a variety of configurations using a fixed bed reactor or a fluidized bed reactor. In many embodiments of the present invention, an “adiabatic” reactor can be used; that is, there is little or no need for internal plumbing through the reaction zone to add or remove heat. In other embodiments, a radial flow reactor or reactors may be employed as the reactor, or a series of reactors may be employed with or without heat exchange, quenching, or introduction of additional feed material. Alternatively, a shell and tube reactor provided with a heat transfer medium may be used. In many cases, the reaction zone may be housed in a single vessel or in a series of vessels with heat exchangers therebetween.

In preferred embodiments, the catalyst is employed in a fixed bed reactor, e.g., in the shape of a pipe or tube, where the reactants, typically in the vapor form, are passed over or through the catalyst. Other reactors, such as fluid or ebullient bed reactors, can be employed. In some instances, the hydrogenation catalysts may be used in conjunction with an inert material to regulate the pressure drop of the reactant stream through the catalyst bed and the contact time of the reactant compounds with the catalyst particles. In some embodiments, multiple catalyst beds are employed in the same reactor or in different reactors, e.g., in series. For example, in one embodiment, a first catalyst functions in a first catalyst stage as a catalyst for the hydrogenation of a carboxylic acid, e.g., acetic acid, to its corresponding alcohol, e.g., ethanol, and a second bifunctional catalyst is employed in the second stage for converting unreacted acetic acid to ethanol as well as converting byproduct ester, e.g., ethyl acetate, to additional products, preferably to ethanol. The catalysts of the invention may be employed in either or both the first and/or second stages of such reaction systems.

The hydrogenation in the reactor may be carried out in either the liquid phase or vapor phase. Preferably, the reaction is carried out in the vapor phase under the following conditions. The reaction temperature may range from 125° C. to 350° C., e.g., from 200° C. to 325° C., or from 250° C. to 300° C. The pressure may range from 10 kPa to 3000 kPa, e.g., from 50 kPa to 2300 kPa, or from 100 kPa to 2000 kPa. The reactants may be fed to the reactor at a gas hourly space velocity (GHSV) of greater than 500 hr⁻¹, e.g., greater than 1000 hr⁻¹, greater than 2500 hf⁻¹ or even greater than 5000 hr⁻¹.

The hydrogenation optionally is carried out at a pressure just sufficient to overcome the pressure drop across the catalytic bed at the GHSV selected, although there is no bar to the use of higher pressures, it being understood that considerable pressure drop through the reactor bed may be experienced at high space velocities, e.g., 5000 hr⁻¹ or 6,500 hr⁻¹.

Although the reaction consumes two moles of hydrogen per mole of acetic acid to produce one mole of ethanol, the actual molar ratio of hydrogen to acetic acid in the feed stream may vary from about 100:1 to 1:100, e.g., from 50:1 to 1:50, from 20:1 to 1:2, or from 18:1 to 2:1. Most preferably, the molar ratio of hydrogen to acetic acid is greater than 2:1, e.g., greater than 4:1 or greater than 8:1. For a mixed feed stream, the molar ratio of hydrogen to ethyl acetate may be greater than 5:1, e.g., greater than 10:1 or greater than 15:1.

Contact or residence time can also vary widely, depending upon such variables as amount of feed stream (acetic acid and/or ethyl acetate), catalyst, reactor, temperature, and pressure. Typical contact times range from a fraction of a second to more than several hours when a catalyst system other than a fixed bed is used, with preferred contact times, at least for vapor phase reactions, from 0.1 to 100 seconds, e.g., from 0.3 to 80 seconds or from 0.4 to 30 seconds.

In particular, by employing the catalysts of the invention, the hydrogenation of acetic acid and/or ethyl acetate may achieve favorable conversion and favorable selectivity and productivity to ethanol in the reactor. For purposes of the present invention, the term “conversion” refers to the amount of acetic acid or ethyl acetate, whichever is specified, in the feed that is converted to a compound other than acetic acid or ethyl acetate, respectively. Conversion is expressed as a percentage based on acetic acid or ethyl acetate in the feed. The acetic acid conversion may be at least 90% over a time on stream of at least 200, more preferably at least 90% over a time on stream of at least 250. Higher conversions may be possible, such as at least 95% or at least 98%.

During the hydrogenation of acetic acid, ethyl acetate may be produced as a byproduct. Without consuming any ethyl acetate from the mixed vapor phase reactants, the conversion of ethyl acetate would be deemed negative. Some of the catalysts described herein are monofunctional in nature and are effective for converting acetic acid to ethanol, but not for converting ethyl acetate. The use of monofunctional catalysts may result in the undesirable build up of ethyl acetate in the system, particularly for systems employing one or more recycle streams that contain ethyl acetate to the reactor.

The preferred catalysts of the invention, however, are multifunctional in that they effectively catalyze the conversion of acetic acid to ethanol as well as the conversion of an alkyl acetate, such as ethyl acetate, to one or more products other than that alkyl acetate. The multifunctional catalyst is preferably effective for consuming ethyl acetate at a rate sufficiently great so as to at least offset the rate of ethyl acetate production, thereby resulting in a non-negative ethyl acetate conversion, i.e., no net increase in ethyl acetate is realized. The use of such catalysts may result, for example, in an ethyl acetate conversion that is effectively 0% or that is greater than 0%. In some embodiments, the catalysts of the invention are effective in providing ethyl acetate conversions of at least 0%, e.g., at least 5%, at least 10%, at least 15%, at least 20%, or at least 35%.

In continuous processes, the ethyl acetate being added (e.g., recycled) to the hydrogenation reactor and ethyl acetate leaving the reactor in the crude product preferably approaches a certain level after the process reaches equilibrium. The use of a multifunctional catalyst that catalyzes the conversion of ethyl acetate as well as acetic acid results in a lower amount of ethyl acetate added to the reactor and less ethyl acetate produced relative to monofunctional catalysts. In preferred embodiments, the concentration of ethyl acetate in the mixed feed and crude product is less than 40 wt. %, less than 25 wt. % or less than 15 wt. %, after equilibrium has been achieved. In preferred embodiments, the process forms a crude product comprising ethanol and ethyl acetate, and the crude product has an ethyl acetate steady state concentration from 0.1 to 40 wt. %, e.g., from 0.1 to 20 wt. % or from 0.1 to 15 wt. %.

Although catalysts that have high acetic acid conversions are desirable, such as at least 60%, in some embodiments a low conversion may be acceptable at high selectivity for ethanol. It is, of course, well understood that in many cases, it is possible to compensate for conversion by appropriate recycle streams or use of larger reactors, but it is more difficult to compensate for poor selectivity.

Selectivity is expressed as a mole percent based on converted acetic acid and/or ethyl acetate. It should be understood that each compound converted from acetic acid and/or ethyl acetate has an independent selectivity and that selectivity is independent of conversion. For example, if 60 mole % of the converted acetic acid is converted to ethanol, we refer to the ethanol selectivity as 60%. For purposes of the present invention, the total selectivity is based on the combined converted acetic acid and ethyl acetate. Preferably, total selectivity to ethanol is at least 60%, e.g., at least 70%, or at least 80%, at least 85% or at least 88%. Preferred embodiments of the hydrogenation process also have low selectivity to undesirable products, such as methane, ethane, and carbon dioxide. The selectivity to these undesirable products preferably is less than 4%, e.g., less than 2% or less than 1%. More preferably, these undesirable products are present in undetectable amounts. Formation of alkanes may be low, and ideally less than 2%, less than 1%, or less than 0.5% of the acetic acid passed over the catalyst is converted to alkanes, which have little value other than as fuel.

The term “productivity,” as used herein, refers to the grams of a specified product, e.g., ethanol, formed during the hydrogenation based on the kilograms of catalyst used per hour. A productivity of at least 100 grams of ethanol per kilogram of catalyst per hour, e.g., at least 400 grams of ethanol per kilogram of catalyst per hour or at least 600 grams of ethanol per kilogram of catalyst per hour, is preferred. In terms of ranges, the productivity preferably is from 100 to 3,000 grams of ethanol per kilogram of catalyst per hour, e.g., from 400 to 2,500 grams of ethanol per kilogram of catalyst per hour or from 600 to 2,000 grams of ethanol per kilogram of catalyst per hour.

In various embodiments of the present invention, the crude ethanol product produced by the reactor, before any subsequent processing, such as purification and separation, will typically comprise unreacted acetic acid, ethanol and water. Exemplary compositional ranges for the crude ethanol product are provided in Table 1. The “others” identified in Table 1 may include, for example, esters, ethers, aldehydes, ketones, alkanes, and carbon dioxide.

TABLE 1
CRUDE ETHANOL PRODUCT COMPOSITIONS

| | Conc. | Conc. | Conc. | Conc. |
|---|---|---|---|---|
| Component | (wt. %) | (wt. %) | (wt. %) | (wt. %) |
| Ethanol | 5 to 72 | 15 to 72 | 15 to 70 | 25 to 65 |
| Acetic Acid | 0 to 90 | 0 to 50 | 0 to 35 | 0 to 15 |
| Water | 5 to 40 | 5 to 30 | 10 to 30 | 10 to 26 |
| Ethyl Acetate | 0 to 30 | 1 to 25 | 3 to 20 | 5 to 18 |
| Acetaldehyde | 0 to 10 | 0 to 3 | 0.1 to 3 | 0.2 to 2 |
| Others | 0.1 to 10 | 0.1 to 6 | 0.1 to 4 | — |

In one embodiment, the crude ethanol product may comprise acetic acid in an amount less than 20 wt. %, e.g., of less than 15 wt. %, less than 10 wt. % or less than 5 wt. %. In terms of ranges, the acetic acid concentration of Table 1 may range from 0.1 wt. % to 20 wt. %, e.g., 0.1 wt. % to 15 wt. %, from 0.1 wt. % to 10 wt. % or from 0.1 wt. % to 5 wt. %. In embodiments having lower amounts of acetic acid, the conversion of acetic acid is preferably greater than 75%, e.g., greater than 85% or greater than 90%. In addition, the selectivity to ethanol may also be preferably high, and is greater than 75%, e.g., greater than 85% or greater than 90%.

An ethanol product may be recovered from the crude ethanol product produced by the reactor using the catalyst of the present invention may be recovered using several different techniques.

The ethanol product may be an industrial grade ethanol comprising from 75 to 96 wt. % ethanol, e.g., from 80 to 96 wt. % or from 85 to 96 wt. % ethanol, based on the total weight of the ethanol product. The industrial grade ethanol may have a water concentration of less than 12 wt. % water, e.g., less than 8 wt. % or less than 3 wt. %. In some embodiments, when further water separation is used, the ethanol product preferably contains ethanol in an amount that is greater than 96 wt. %, e.g., greater than 98 wt. % or greater than 99.5 wt. %. The ethanol product having further water separation preferably comprises less than 3 wt. % water, e.g., less than 2 wt. % or less than 0.5 wt. %.

The finished ethanol composition produced by the embodiments of the present invention may be used in a variety of applications including fuels, solvents, chemical feedstocks, pharmaceutical products, cleansers, sanitizers, hydrogen transport or consumption. In fuel applications, the finished ethanol composition may be blended with gasoline for motor vehicles such as automobiles, boats and small piston engine aircraft. In non-fuel applications, the finished ethanol composition may be used as a solvent for toiletry and cosmetic preparations, detergents, disinfectants, coatings, inks, and pharmaceuticals. The finished ethanol composition may also be used as a processing solvent in manufacturing processes for medicinal products, food preparations, dyes, photochemicals and latex processing.

The finished ethanol composition may also be used as a chemical feedstock to make other chemicals such as vinegar, ethyl acrylate, ethyl acetate, ethylene, glycol ethers, ethylamines, ethyl benzene, aldehydes, butadiene, and higher alcohols, especially butanol. In the production of ethyl acetate, the finished ethanol composition may be esterified with acetic acid. In another application, the finished ethanol composition may be dehydrated to produce ethylene. Any known dehydration catalyst, such as zeolite catalysts or phosphotungstic acid catalysts, can be employed to dehydrate ethanol, as described in U.S. Pub. Nos. 2010/0030002 and 2010/0030001 and WO2010146332, the entire contents and disclosures of which are hereby incorporated by reference.

The following examples describe the catalyst and process of this invention.

### EXAMPLES

### Example 1

A catalyst comprising platinum and tin on a modified support comprising silica modified with tungsten and cobalt was prepared as follows.

### A. Preparation of Modified Support: CoWO₃/SiO₂

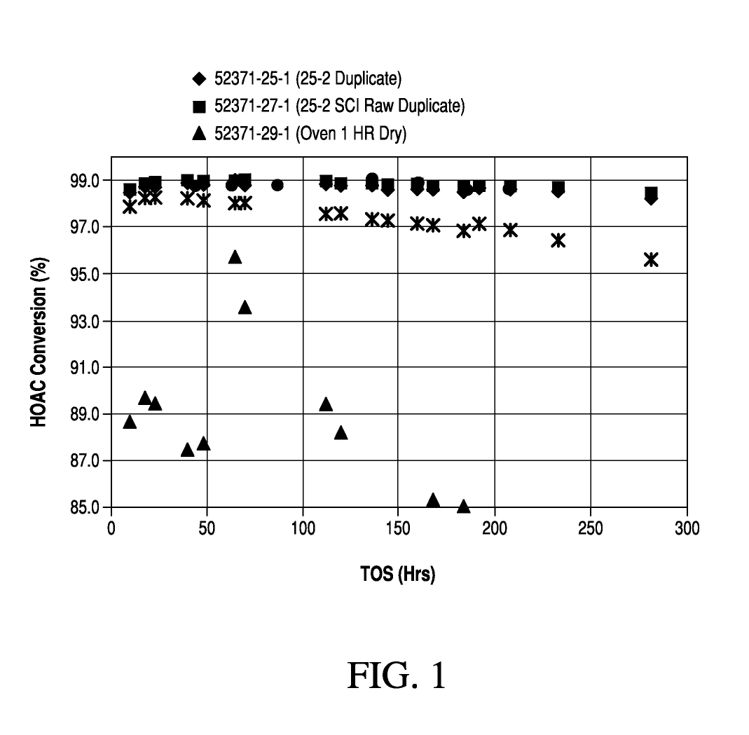

A summary of the catalyst preparation protocol is provided in FIG. 1. A metal impregnation solution was prepared as follows. First, a solution of cobalt salt was prepared by adding Co(NO₃)₂.6H₂O solid into DI—H₂O. After Co salt was completely dissolved, AMT (Ammonium metatungstate hydrate) was added to the above solution. The mixture was then stirred at 400 rpm for 5 minutes at room temperature. The impregnation solution was then added to the SiO₂ support in a round flask to get uniform distribution on the support. After adding the metal solution, the material was evacuated to dryness with rotary evaporator with bath temperature at 80° C. and vacuum at 72 mbar for 1 hour, followed by drying at 120° C. for 12 hours under circulating air.

The calcination was carried out in a furnace with temperature program from room temperature to 160° C. with 3° C./min rate, hold at 160° C. for 2 hours; hold at 550° C. for 6 hours with 3° C./min ramp rate from 160° C.

### B. Impregnation of Modified Support: PtSn/CoWO₃/SiO₂

A tin metal solution was prepared as follows. First, a solution of ammonium oxalate was prepared by adding (NH₄)₂C₂O₄.H₂O solid into DI—H₂O. After ammonium oxalate was completely dissolved by heating up to 60° C., tin oxalate was added to above solution. After this salt was completely dissolved, this solution was cooled down to room temperature. A Pt metal solution was made by adding PtC₂O₄ solution to DI—H₂O. This solution was combined with tin solution to make impregnation solution.

Approximately one half of the impregnation solution was then added to the modified silica support in a round flask to get uniform distribution on the support. This solution included 17.2 g water. After adding the metal solution, the material was evacuated with a rotary evaporator with bath temperature at 80° C. and vacuum at 72 mbar for 1 hour. After 1 hour, the water concentration was 8.73 wt. %. The catalyst was then dried at 120° C. for 12 hours under circulating air. After 12 hours, the catalyst comprised 5.68 wt. % water.

Approximately one half of the impregnation solution was added to the modified silica support. This second solution comprised 15.71 g water. After adding the metal solution, the material was evacuated with a rotary evaporator with bath temperature at 80° C. and vacuum at 72 mbar for 1 hour. After 1 hour, the catalyst comprised 16.49 wt. % water. The catalyst was then dried at 120° C. for 5 hours under circulating air. After 5 hours, the water concentration was 14.56 wt. %.

The calcination was carried out in a furnace with temperature program from room temperature to 160° C. with 3° C./min rate, hold at 160° C. for 2 hours; hold at 350° C. for 6 hours with 3° C./min ramp rate from 160° C.

FIG. 1 shows that a catalyst prepared by the method of Example 1, labeled as 52371-25-1 and 52371-27-1, had a conversion of acetic acid of greater than 95% over a time on stream of greater than 250 hours. The comparative example, labeled as 52371-29-1, was subjected only to a 1 hour oven dry and comprised greater than 20 wt. % water. This catalyst had conversion of acetic acid of less than 97% and dropped in conversion of acetic acid to 85% over a time on stream of less than 200 hours.

While the invention has been described in detail, modifications within the spirit and scope of the invention will be readily apparent to those skilled in the art. All publications and references discussed above are incorporated herein by reference. In addition, it should be understood that aspects of the invention and portions of various embodiments and various features recited may be combined or interchanged either in whole or in part. In the foregoing descriptions of the various embodiments, those embodiments which refer to another embodiment may be appropriately combined with other embodiments as will be appreciated by one skilled in the art. Furthermore, those skilled in the art will appreciate that the foregoing description is by way of example only, and is not intended to limit the invention.

We claim:

1. A process for producing ethanol, comprising contacting a feedstock comprising acetic acid, ethyl acetate and mixtures thereof with hydrogen in a reactor at an elevated temperature in the presence of a catalyst comprising one or more active metals, under conditions effective to form ethanol;
wherein the catalyst is prepared by impregnating a support with at least one precursor solution comprising a solvent and at least one precursor to the one or more active metals; drying the impregnated support to a water content of less than 20 wt. %; and calcining the dried catalyst to form the catalyst.

2. The process of claim 1, wherein the water concentration of the dried catalyst is from 0.1 to 15 wt. % water prior to calcining.

3. The process of claim 1, wherein the catalyst is dried for at least 10 hours prior to calcining.

4. The process of claim 1, wherein the catalyst is dried for at least 15 hours prior to calcining.

5. The process of claim 1, wherein the one or more active metals are selected from the group consisting of rhodium, rhenium, ruthenium, platinum, palladium, osmium, iridium, gold copper, iron, vanadium, tin, cobalt, nickel, titanium, zinc, chromium, molybdenum, tungsten, lanthanum, cerium, and manganese.

6. The process of claim 1, wherein the one or more active metals are selected from the group consisting of platinum, palladium, tin, cobalt, and nickel.

7. The process of claim 1, wherein the support is selected from the group consisting of silica, alumina, titania, silica/alumina, pyrogenic silica, high purity silica, zirconia, carbon, zeolites and mixtures thereof.

8. The process of claim 1, wherein the support is a modified support and the modified support comprises a support modifier selected from the group consisting of tungsten, molybdenum, vanadium, niobium, and tantalum.

9. The process of claim 8, wherein the modified support further comprises cobalt, tin, or mixtures thereof.

10. The process of claim 1, wherein the precursor solution comprises at least two precursors to active metals.

11. The process of claim 1, wherein the catalyst is prepared by impregnating a first portion of the precursor solution and drying the first portion, and impregnating a second portion of the precursor solution, drying the second portion to have water concentration of less than 20 wt. %, and calcining the dried catalyst.

12. The process of claim 1, wherein conversion of acetic acid is at least 90% over a time on stream of at least 200 hours.

13. The process of claim 1, wherein conversion of acetic acid is at least 95% over a time on stream of at least 250 hours.

14. The process of claim 1, wherein selectivity of acetic acid to ethanol is at least 80%.

15. The process of claim 1, wherein selectivity of acetic acid to ethanol is at least 90%.

16. The process of claim 1, wherein the acetic acid and/or ethyl acetate is derived from a carbonaceous material selected from the group consisting of oil, coal, natural gas and biomass.

17. A hydrogenation catalyst comprising one or more active metals selected from the group consisting of rhodium, rhenium, ruthenium, platinum, palladium, osmium, iridium, gold copper, iron, vanadium, tin, cobalt, nickel, titanium, zinc, chromium, molybdenum, tungsten, lanthanum, cerium, and manganese;
wherein the catalyst is prepared by impregnating a support with at least one precursor solution comprising a solvent and at least one precursor to the one or more active metals; drying the impregnated support to a water content of less than 20 wt. %; and calcining the dried catalyst to form the catalyst.

18. The hydrogenation catalyst of claim 17, wherein after the impregnating, the catalyst comprises at least 30 wt. % water and further wherein after drying but prior to calcining, the catalyst comprises less than 20 wt. % water.

19. The hydrogenation catalyst of claim 17, wherein the catalyst is dried to comprise from 0.1 to 15 wt. % water prior to calcining.

20. The hydrogenation catalyst of claim 17, wherein the one or more active metals are selected from the group consisting of platinum, palladium, tin, cobalt, and nickel.
